(19) United States
(12) Patent Application Publication
(10) Pub. No.: US 2022/0203750 A1
(43) Pub. Date: Jun. 30, 2022

(54) WRITING INSTRUMENTS

(71) Applicant: Société BIC, Clichy (FR)

(72) Inventor: Arnaud BEZ, Clichy (FR)

(73) Assignee: Société BIC, Clichy (FR)

(21) Appl. No.: 17/457,925

(22) Filed: Dec. 7, 2021

(30) Foreign Application Priority Data
Dec. 31, 2020 (EP) 20306716.0

(51) Int. Cl. B43K 8/02; B43K 8/03; B43K 8/04

(52) U.S. Cl. CPC B43K 8/024; B43K 8/04; B43K 8/03

(57) ABSTRACT

A writing instrument comprises a hollow body having a first end and a second opposite end along a longitudinal axis (X); a deformable tank inside the hollow body and containing ink; a writing tip disposed at the first end of the hollow body and in fluid communication with the deformable tank; and a deformation device configured to squeeze the deformable tank along the longitudinal axis (X) so as to move forward towards the writing tip the ink contained in the deformable tank.

### CROSS REFERENCE TO RELATED APPLICATIONS

This application claims priority from European patent application No. EP20306716.0, filed on Dec. 31, 2020, the contents of which are hereby incorporated herein in their entirety by this reference.

### FIELD

The present disclosure relates generally to the field of writing instruments. More specifically, the present disclosure relates to a felt pen.

### BACKGROUND

A conventional writing instrument comprises a body comprising an ink tank and a writing tip in fluid communication with the ink tank. Some writing instruments called felt pens are equipped with a filler system that can supply ink to the writing tip as necessary. Ink supply can be initiated by a user of the writing instrument through a specific mechanism.

A conventional felt pen is known from JP11020374A.

It has been found that on average 20% to 30% of the ink contained in the ink tank of such conventional writing instruments equipped with a filler system cannot be used due to the configuration of these instruments.

### SUMMARY

It is thus desirable to provide a writing instrument that is capable of dispensing to the writing tip more ink from the ink tank than in the prior art. It is particularly desirable to provide a writing instrument that is capable of leaving as less ink as possible in the ink tank after the very last use of the writing instrument.

According to aspects of the disclosure, a writing instrument comprises:
a hollow body having a first end and a second opposite end along a longitudinal axis X;
a deformable tank inside the hollow body and containing ink;
a writing tip disposed at the first end of the hollow body and in fluid communication with the deformable tank;
a deformation device configured to squeeze the deformable tank along the longitudinal axis X so as to move forward towards the writing tip the ink contained in the deformable tank.

This novel configuration makes it possible to deform to a very large extent the deformable tank by squeezing the latter along the longitudinal axis of the body over at least a part of the longitudinal extension of the tank inside the body. Thus, the volume or quantity of ink remaining in the tank after the last possible use may, in some instances where the latter has been deformed to its most squeezed state, be close to zero. A configuration of a writing instrument with improved capacity of dispensing ink towards its writing tip can therefore be obtained.

According to possible aspects of the disclosure, the deformation device is further configured to squeeze the deformable tank in a transverse direction relative to the longitudinal axis X.

According to possible aspects of the disclosure, the deformable tank is a porous or fibrous tank.

According to possible aspects of the disclosure, the deformation device comprises a mobile member disposed inside the hollow body and connected to the deformable tank, the mobile member being configured to move along the longitudinal axis by squeezing the deformable tank from a first longitudinal position distant from the writing tip and in which the tank contains a first volume of ink to a second longitudinal position proximate the writing tip and in which the tank contains a second volume of ink that is less than the first volume of ink.

According to aspects of the disclosure, the mobile member comprises a slider that is configured to slide longitudinally inside the hollow body from the first longitudinal position to the second longitudinal position by squeezing the deformable tank.

According to possible aspects of the disclosure, the slider comprises a body having a through hole along the longitudinal axis X, the through hole being configured to receive a portion of the deformable tank.

According to possible aspects of the disclosure, the slider is configured to slide longitudinally around successive portions of the deformable tank towards a front end of the latter that is in fluid communication with the writing tip, thereby squeezing gradually the whole deformable tank portion by portion.

According to possible aspects of the disclosure, the through hole has, in a transverse cross-section relative to the longitudinal axis, a first transverse dimension L that is greater than an outside transverse dimension of the deformable tank and a second transverse dimension h that is less than the outside transverse dimension of the deformable tank.

According to possible aspects of the disclosure, the writing instrument further comprises one or more guiding members that are configured to guide longitudinally the slider in the course of its sliding movement along the longitudinal axis X.

According to possible aspects of the disclosure, the writing instrument further comprises an actuating member configured to actuate the deformation device so as to cause the latter to squeeze the deformable tank.

According to possible aspects of the disclosure, the actuating member comprises a rotating body that is connected to the mobile member and configured to rotate about the longitudinal axis X so as to cause the mobile member to move longitudinally from the first longitudinal position to the second longitudinal position.

According to possible aspects of the disclosure, the writing instrument comprises a helical path configured to engage with the mobile member.

According to further possible aspects of the disclosure, the body of the writing instrument or the rotating body of the actuating member may comprise a helical path configured to engage with the mobile member.

According to possible aspects of the disclosure, the slider comprises a cam path follower configured to engage with the helical path and travel along the helical path when the rotating body is caused to rotate about the longitudinal axis X with respect to the body of the writing instrument.

According to possible aspects of the disclosure, the cam path follower is configured to extend through the helical path so as to engage with the one or more guiding members.

According to possible aspects of the disclosure, the cam path follower is arranged at an outer periphery of the slider.

According to possible aspects of the disclosure, the writing tip is a porous tip.

### BRIEF DESCRIPTION OF THE DRAWINGS

Aspects of embodiments will be described in reference to the drawings, where like numerals reflect like elements:

FIG. 1 is a longitudinal cross-section view of a felt pen 10 according to aspects of the disclosure of an exemplary embodiment;

FIG. 2 is a cross-section view of the slider 22 of FIG. 1;

FIG. 3 is a longitudinal view of the slider 22 of FIG. 1;

FIG. 4 is a longitudinal view of the actuating member 16 of FIG. 1;

FIG. 5 is a cross-section view of the barrel portion 18a and guiding members 18c-d of FIG. 1;

FIG. 6 is a partial longitudinal cross-section view of a felt pen 10′ according to aspects of the disclosure of another exemplary embodiment;

FIG. 7 is a cross-section view of the slider 22′ of FIG. 6.

### DETAILED DESCRIPTION

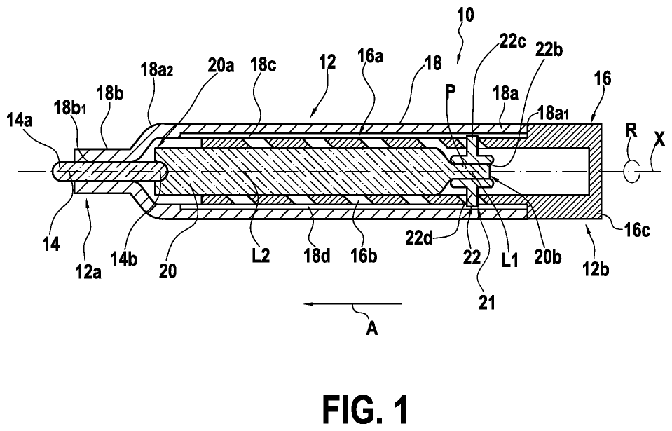

An embodiment of the felt pen according to aspects of the disclosure will now be described with reference to FIGS. 1 to 7. Although the felt pen is described with reference to specific examples, it should be understood that modifications and changes may be made to these examples without going beyond the general scope as defined by the claims. In particular, individual characteristics of the various embodiments shown and/or mentioned herein may be combined in additional embodiments. Consequently, the description and the drawings should be considered in a meaning that is illustrative rather than restrictive. The Figures, which are not necessarily to scale, depict illustrative aspects and are not intended to limit the scope of the disclosure. The illustrative aspects depicted are intended only as exemplary.

The term “exemplary” is used in the meaning of “example,” rather than “ideal.” While aspects of the disclosure are amenable to various modifications and alternative forms, specifics thereof have been shown by way of example in the drawings and will be described in detail. It should be understood, however, that the intention is not to limit aspects of the disclosure to the particular embodiment(s) described. On the contrary, the intention of this disclosure is to cover all modifications, equivalents, and alternatives falling within the scope of the disclosure.

Various materials, methods of construction and methods of fastening will be discussed in the context of the disclosed embodiment(s). Those skilled in the art will recognize known substitutes for the materials, construction methods, and fastening methods, all of which are contemplated as compatible with the disclosed embodiment(s) and are intended to be encompassed by the appended claims.

As used in this disclosure and the appended claims, the singular forms “a,” “an,” and “the” include plural referents unless the content clearly dictates otherwise. As used in this disclosure and the appended claims, the term “or” is generally employed in its meaning including “and/or” unless the content clearly dictates otherwise.

Throughout the description, including the claims, the terms “comprising a,” “including a,” and “having a” should be understood as being synonymous with “comprising one or more,” “including one or more,” and “having one or more” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially,” “approximately,” and “generally” should be understood to mean falling within such accepted tolerances.

When an element or feature is referred to herein as being “on,” “engaged to,” “connected to,” or “coupled to” another element or feature, it may be directly on, engaged, connected, or coupled to the other element or feature, or intervening elements or features may be present. In contrast, when an element or feature is referred to as being “directly on,” “directly engaged to,” “directly connected to,” or “directly coupled to” another element or feature, there may be no intervening elements or features present. Other words used to describe the relationship between elements or features should be interpreted in a like fashion (e.g., “between” versus “directly between,” “adjacent” versus “directly adjacent,” etc.).

Spatially relative terms, such as “top,” “bottom,” “middle,” “inner,” “outer,” “beneath,” “below,” “lower,” “above,” “upper,” and the like, may be used herein for ease of description to describe one element or feature's relationship to another element(s) or feature(s) as illustrated in the drawings. Spatially relative terms may be intended to encompass different orientations of a device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below.

Although the terms “first,” “second,” etc. may be used herein to describe various elements, components, regions, layers, sections, and/or parameters, these elements, components, regions, layers, sections, and/or parameters should not be limited by these terms. These terms are only used to distinguish one element, component, region, layer, or section from another region, layer, or section. Thus, a first element, component, region, layer, or section discussed herein could be termed a second element, component, region, layer, or section without departing from the teachings of the present disclosure.

As shown in FIGS. 1 to 5 the writing instrument 10 is a felt pen in the present exemplary embodiment.

In this embodiment the felt pen 10 illustrated in a longitudinal cross section on FIG. 1 comprises a body 12 with an elongated shape along a longitudinal axis X. The axis X can take any spatial orientation (vertical, horizontal, inclined relative to both vertical and horizontal) but, here, the felt pen 10 is represented in a horizontal position for the sake of simplicity. However, it should not be interpreted that the felt pen is in a storage position.

More particularly, the body 12 may be substantially hollow. The body 12 has a first end 12a and a second opposite end 12b that may be both aligned along the longitudinal axis X.

The body 12 may comprise a writing tip 14 at the first end 12a and an actuating member 16 at the second opposite end 12b.

The writing tip 14 may be a porous or fibrous tip of a conventional type.

The actuating member 16 may be configured to actuate a mechanism inside the body 12 and may also be actuated externally by a user as will be described later on.

The body 12 may comprise a barrel 18 that may extend along a substantial portion of the overall longitudinal dimension or length of the body. The barrel 18 may be substantially hollow and may comprise a substantially cylindrical portion 18a that extends from a first end 18a1 adjacent the actuating member 16 to a second opposite end 18a2 aligned with the first end along the axis X. The substantially cylindrical portion 18a extends along a main portion of the barrel 18 and has a first transverse dimension or diameter. The barrel 18 may further comprise a constricted portion 18b that extends from the second opposite end 18a2 of the substantially cylindrical portion 18a to the first end 12a of the body 12. The constricted portion 18b has a reduced second transverse dimension or diameter relative to the first transverse dimension or diameter of substantially cylindrical portion 18a. The constricted portion 18b may have a traversing longitudinally-extending hole 18b1 that leads externally and is configured to accommodate the writing tip 14 and permanently retain the latter in a working position after it has been forcibly engaged therethrough.

The felt pen 10 may further comprise a deformable tank 20 that is impregnated with ink, in particular a deformable porous or fibrous tank 20 in the exemplary embodiment. The tank 20 may be disposed inside the body 12 and, more particularly, inside the hollow substantially cylindrical portion 18a of the barrel 18. The tank may take an elongated shape inside the body 12. The tank 20 and writing tip 14 may be connected to each other so as to be in fluid communication and, in particular, enable a flow of ink to take place from the tank 20 towards the writing tip 14. More particularly, the writing tip 14 has a first end 14a that is located outside the body 12 and a second opposite end 14b that is located inside the body and in connection with a first end 20a, or front end, of the tank 20. The writing tip 14 may penetrate inside the tank body over a distance that is sufficient to ensure a capillarity connection between the tip and the tank. A penetration distance of e.g. 5 mm may be used, although other penetration distances may be envisaged. The tank 20 has a second opposite end 20b that is aligned with the first end 20a along the longitudinal axis X and that will be further described.

The tank 20 may comprise a porous or fibrous structure of a known type. It may be for example a 3D structure that comprises a mix of material and interconnected pores or cells or cavities bounded by material and that can be filled with ink (e.g. a mesh of interconnected space voids). The interconnected structure makes it possible for the ink contained in the pores to migrate from pore to pore throughout the 3D structure when submitted to an external squeezing or compression force or constraint. Alternatively, the 3D structure may comprise a mix of fibers and void spaces around them so as accommodate ink therein. Also, when the 3D structure is submitted to an external squeezing or compression force or constraint, the ink contained in the void spaces can migrate along them and the fibers throughout the 3D structure. By way of example, an ink tank structure may be composed of extruded Polyethylene (PE) fibers maintained all together by an external PE layer or sleeve. This tank structure has the capacity of being deformed when squeezed or compressed under an external squeezing or compression force or constraint. Such a squeezing or compression force or constraint applied to the deformable structure may force the ink contained in the structure to flow away from the location in the structure where the force or constraint is applied. In the present exemplary embodiment, when a squeezing or compression force or constraint is applied to the deformable structure along the longitudinal axis X, the ink contained in the squeezed/compressed part of the latter may be caused to flow substantially longitudinally. In particular, when a squeezing or compression force or constraint is applied to the second end 20b of the deformable structure along the longitudinal axis X, then a flow of ink may take place towards the first end 20a of the deformable structure that is in fluid communication with the writing tip 14 so as to supply ink thereto.

It is to be noted that, in the present exemplary embodiment, a squeezing or compression force or constraint may also be applied externally to the outside of the deformable structure in a transverse direction so as to also radially squeeze or compress the latter. Thus a squeezing or compression force or constraint is applied simultaneously both longitudinally and transversely to the deformable structure in order to cause the ink contained in the squeezed/compressed part of the latter to flow away from this part, i.e. towards the first end 20a.

As the deformable structure of the tank has an elongated shape along the longitudinal axis X and is configured to be deformed along this axis and transversally relative thereto through an external force or constraint as described above, the whole structure of the tank may be submitted to this deformation force or constraint, thereby enabling the most part of the whole volume of ink contained in the tank structure (at best almost the whole volume of ink) to be pressed on and caused to flow towards the writing tip 14 so as to be expelled out of the tank. Thanks to this configuration and an external force of constraint applied to one end of the deformable tank, the latter is able to switch from a first state where the deformable tank contains a first volume of ink, e.g. the original state where the felt pen 10 has not yet been used and the volume of ink is at a maximum value, to a second state where the deformable tank contains a reduced second volume of ink that is less than the first volume of ink. Ideally, the second volume of ink may be as close as possible to the zero value so as to use as much ink contained in the tank as possible.

In another exemplary embodiment that is not further discussed herein, the deformable tank structure may be flexible enough for it to return to its original non deformed shape in the absence of squeezing or compression force or constraint applied thereon.

In the present exemplary embodiment, the felt pen 10 may further comprise a deformation device 21 that is configured to apply a force or constraint to the deformable tank 20 both in a longitudinal and a transverse direction so as to axially and radially squeeze or compress the latter and thus move forward towards the writing tip 14 the ink that is contained in the tank.

The deformation device 21 may comprise a mobile member that is disposed inside the barrel 18, more particularly inside its hollow substantially cylindrical portion 18a, and that is connected to the second end 20b of the deformable tank 20. The mobile member is configured to move along the longitudinal axis X by squeezing/compressing the deformable tank 20 from a first longitudinal position L1 (see FIG. 1) distant from the writing tip 14 and in which the tank contains a first volume of ink (this corresponds to the above first state of the tank) to a second longitudinal position L2 proximate the writing tip 14 and in which the tank contains a second volume of ink (this corresponds to the above second state of the tank) that is less than the first volume of ink. In this second longitudinal position L2 the mobile member is blocked by the tip area (tip end 14b) inserted inside the tank and cannot slide anymore because the tank cannot be compressed due to the nib inside, and the mobile member has reached a final position. Almost all the ink of the tank, i.e. at least 90% or more of the ink which has been extracted has been gradually supplied to the writing tip 14 in the course of use of the felt pen.

In the present exemplary embodiment, the mobile member may comprise a slider 22 that is configured to slide longitudinally along the axis X inside the barrel 18 from the first longitudinal position L1 to the second longitudinal position L2 by squeezing/compressing the deformable porous or fibrous tank 20, portion by portion, as it moves longitudinally. In particular, the slider 22 may be configured to receive a portion of the deformable tank 20 in a through hole and radially squeeze or compress this portion as illustrated in FIG. 1. In the FIG. 1 position this portion is an end portion of the tank that includes the second end 20b of the latter and that is surrounded by the slider. This portion is radially squeezed/compressed and thus has reduced transverse dimensions in a transverse cross section with respect to the greater transverse dimensions of the remaining part of the tank not yet deformed. As the slider 22 moves forward towards the writing tip 14, along the longitudinal direction indicated by the horizontal arrow A, it is configured to gradually deform successive portions of the deformable tank along axis X and transversally thereto by forcing each portion to pass inside the slider through hole where the whole ink contained in the portion is pressed out and forced to flow towards the remaining part of the tank not yet deformed, i.e. towards the first end 20a. This gradual deformation corresponds both to a squeezing/compression in a radial/transverse direction and along the longitudinal axis X, which results in pressing out almost all, i.e. at least 90% or more of the ink contained in the deformable tank when the slider 22 reaches the second and final longitudinal position L2.

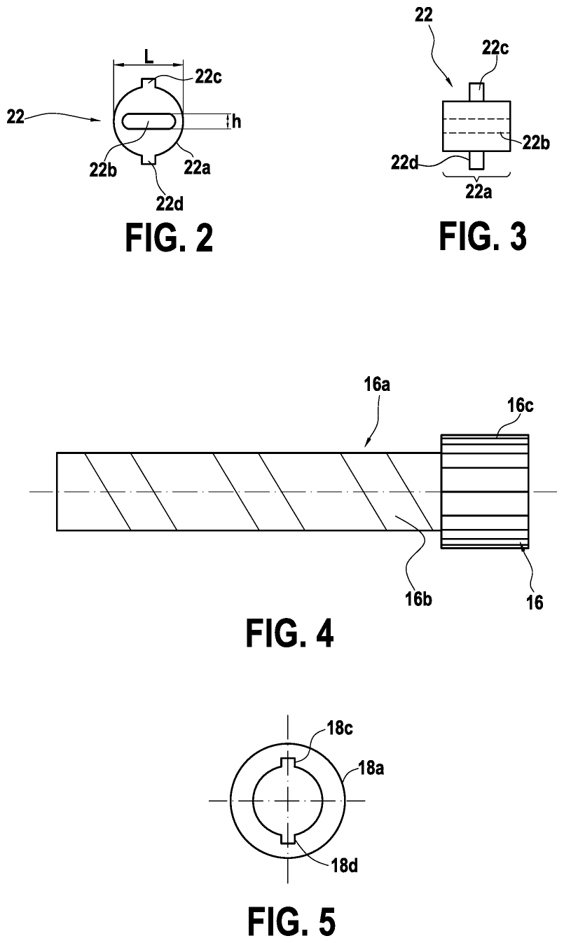

As more particularly represented in FIGS. 1 to 3, the slider 22 may comprise a substantially cylindrical body 22a with a central through hole 22b whose transverse dimensions (FIG. 2) are defined by a first transverse dimension L and a second transverse dimension h, perpendicular to the first dimension L. The first transverse dimension L may be greater than an outside transverse dimension of the deformable tank and the second transverse dimension h may be less than the outside transverse dimension of the deformable tank. Thus, the through hole 22b of the slider 22 is configured to accommodate therein a radially squeezed/compressed portion P of the deformable tank and to retain it in position. Before the first use of the felt pen the slider 22 is connected to the deformable tank in this manner.

In the present exemplary embodiment, the deformable tank 20 may have a substantially cylindrical shape and an outside transverse dimension of the deformable tank corresponds here to its outer diameter. The minimum possible dimension for h may be of about one-third (⅓) of the outer diameter of the deformable tank, and here h may be specifically half the outer diameter of the deformable tank (overall the value for h will depend on the porosity density or fibers density). The minimum possible dimension for L may be of about 1.5 times the outer diameter of the deformable tank, and here L may be specifically of two times the outer diameter of the deformable tank.

In order to have the deformation device 21, more particularly the slider 22, move longitudinally along the axis X and squeeze transversally and longitudinally successive longitudinal portions of the deformable tank from its second end 20b towards its first end 20a, the actuating member 16 is configured to actuate the deformation device, i.e. the slider 22, so as to cause the latter to squeeze the deformable tank both longitudinally and transversally.

In this respect, the actuating member 16 may comprise a rotating body that is connected to the slider 22 and configured to rotate about the longitudinal axis X with respect to the slider 22 and relative to the barrel 18 so as to cause the slider 22 to move longitudinally from the first longitudinal position L1 to the second longitudinal position L2.

More particularly, the rotating body 16 may comprise a hollow longitudinal portion 16a extending inside the substantially cylindrical portion 18a of the barrel and around the slider 22. This hollow longitudinal portion 16a may comprise a helical path 16b (FIGS. 1 and 4) that is configured to engage with the slider 22 and, in particular, with a cam path follower of the latter. Such an arrangement makes it possible for the cam path follower of the slider 22 to travel along the helical path 16b when the latter is caused to rotate about the longitudinal axis X with respect to the slider 22 and the barrel 18. It is to be noted that the helical path 16b may take the form of a slot of an helical shape and that traverses the cylindrical wall of the hollow longitudinal portion 16a across its thickness or radial dimension.

As illustrated in FIGS. 1 to 3, the cam path follower of the slider 22 may take the shape of two index or fingers 22c, 22d that may be provided at the outer periphery of the body 22a, more particularly arranged in a diametrically opposed manner so as to both engage simultaneously with two opposite portions of the helical path 16b. The dimensions of the two index or fingers 22c, 22d are suitable for engaging with the helical path 16b and therefore do not extend along the whole longitudinal dimension of the slider body 22a in this configuration.

The two index or fingers 22c, 22d are also appropriately sized in a radial direction so as to fully extend through the helical path 16b and beyond until engaging with one or more guiding members of the body 12, the purpose of which is to longitudinally guide the slider 22 in its longitudinal sliding movement inside the barrel 18 and the rotating body 16a. In particular, the substantially cylindrical portion 18a of the barrel 18 may be provided on its inner surface with two longitudinal grooves 18b, 18c (FIG. 5) that extend along the longitudinal axis X in a diametrically opposed manner and act as guiding members for the cam path follower of slider 22.

Further, the rotating body 16 may also comprise a longitudinal portion 16c that extends longitudinally from an end of the hollow longitudinal portion 16a away from the latter so as to project outside the substantially cylindrical portion 18a of the barrel, here in a flush manner when considering the outer longitudinal surface of the barrel 18. The outside projecting portion 16c (e.g. here a plug) may be handled by a user of the felt pen and twisted about the axis X as indicated by the arrow R in FIG. 1 in order to cause the helical path 16b to rotate about axis X, thus causing the slider 22 to move longitudinally in the direction A while the index or fingers 22c, 22d of the slider that are longitudinally guided through guiding members 18b, 18c travel the rotating helical path 16b. The radial and longitudinal squeezing/compressing effects caused by the longitudinal motion of the slider on the deformable tank 20 lead to a greater quantity of ink to be pushed towards the writing tip 14 and therefore used by the latter than in the past. Thus, thanks to the novel configuration of the felt pen according to this exemplary embodiment, almost no ink or 10% or even less ink is left inside the deformable ink tank. In practice, there still remains a very small quantity or volume of ink inside the tank (residual ink) even after it has been squeezed/compressed to its maximum squeezing/compression capacity. The residual ink corresponds to the very small ink layer which remains on the fibers of the tank. The squeezing/compression capacity of the tank may depend on the size and length of the tank as well as the efficiency of the deformation device/compression member.

The outside projecting portion 16c may be hollow and the two longitudinal portions 16a and 16c may be integral therewith.

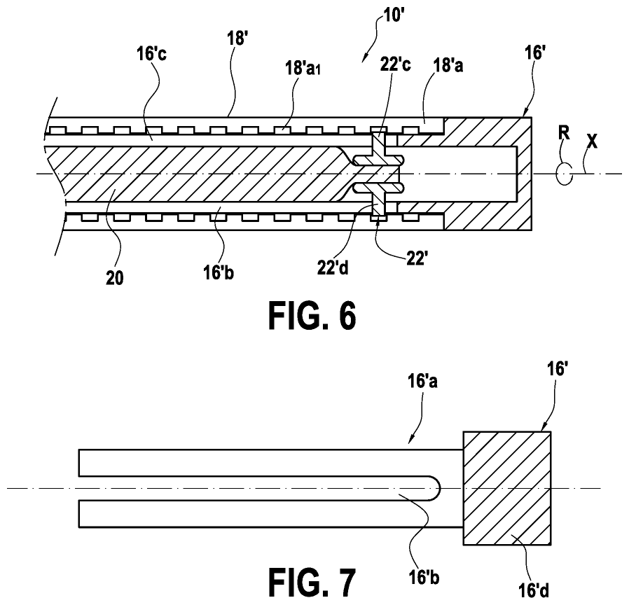

It is to be noted that the reverse mechanism with a rotating slider and a fixed helical path may be envisaged as illustrated in FIGS. 6 and 7.

In the exemplary embodiment of FIGS. 6 and 7 the felt pen 10′ differs from the felt pen 10 in that:
the cam path follower of the slider 22′ is, i.e. here the two index or fingers 22′c, 22′d are in permanent engagement with two diametrically opposite helical portions of a fixed helical path 18′a1 provided on the inner surface of the substantially cylindrical portion 18′a of the barrel 18′ (in the thickness of the wall of the substantially cylindrical portion 18′a) along its length,
the rotating body 16′ (actuating member) comprises a hollow longitudinal portion 16′a that is substantially cylindrical in shape and has two diametrically opposite longitudinal slots 16′b, 16′c along almost its whole length (FIG. 6) which are respectively traversed by the two index or fingers 22′c, 22′d of the slider.

The rotating body 16′ comprises the longitudinal portion 16′d that corresponds to the element referenced 16c in FIGS. 1 and 4 and that can be twisted by a user as indicated by the arrow R on FIG. 6 so as to cause the whole rotating body 16′ to rotate about the axis X, thereby forcing the slider 22′ (the slider 22′ is blocked in rotation relative to the rotating body) to travel the fixed helical path in the barrel 18′. The slider 22′ is thus caused to rotate and move axially inside the barrel and squeeze/compress the deformable tank as described above in relation with the FIGS. 1 to 5. Apart from the above, the exemplary embodiment of FIGS. 6 and 7 has the same features and advantages as those mentioned above in relation with the exemplary embodiment of FIGS. 1 to 5 and they will not be repeated here.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

Additionally, all of the disclosed features of a writing instrument may be transposed, alone or in combination, to a method for operating a writing instrument and vice versa.

1. A writing instrument comprising:
a hollow body having a first end and a second opposite end along a longitudinal axis;
a deformable tank inside the hollow body and containing ink;
a writing tip disposed at the first end of the hollow body and in fluid communication with the deformable tank; and
a deformation device configured to squeeze the deformable tank along the longitudinal axis so as to move forward towards the writing tip the ink contained in the deformable tank.

2. The writing instrument of claim 1, wherein the deformation device is further configured to squeeze the deformable tank in a transverse direction relative to the longitudinal axis.

3. The writing instrument of claim 1, wherein the deformable tank is a porous or fibrous tank.

4. The writing instrument of claim 1, wherein the deformation device comprises a mobile member disposed inside the hollow body and connected to the deformable tank, the mobile member being configured to move along the longitudinal axis by squeezing the deformable tank from a first longitudinal position distant from the writing tip and in which the tank contains a first volume of ink to a second longitudinal position proximate the writing tip and in which the tank contains a second volume of ink that is less than the first volume of ink.

5. The writing instrument of claim 4, wherein the mobile member comprises a slider that is configured to slide longitudinally inside the hollow body from the first longitudinal position to the second longitudinal position by squeezing the deformable tank.

6. The writing instrument of claim 5, wherein the slider comprises a body having a through hole along the longitudinal axis, the through hole being configured to receive a portion of the deformable tank.

7. The writing instrument of claim 5, wherein the slider is configured to slide longitudinally around successive portions of the deformable tank towards a front end of the latter that is in fluid communication with the writing tip, thereby squeezing gradually the whole deformable tank portion by portion.

8. The writing instrument of claim 6, wherein the through hole has, in a transverse cross-section relative to the longitudinal axis, a first transverse dimension that is greater than an outside transverse dimension of the deformable tank and a second transverse dimension that is less than the outside transverse dimension of the deformable tank.

9. The writing instrument of claim 5, wherein the writing instrument further comprises one or more guiding members that are configured to guide longitudinally the slider in the course of its sliding movement along the longitudinal axis.

10. The writing instrument of claim 1, wherein the writing instrument further comprises an actuating member configured to actuate the deformation device so as to cause the latter to squeeze the deformable tank.

11. The writing instrument of claim 10, wherein the actuating member comprises a rotating body that is connected to the mobile member and configured to rotate about the longitudinal axis so as to cause the mobile member to move longitudinally from the first longitudinal position to the second longitudinal position.

12. The writing instrument of claim 1, wherein the writing instrument comprises a helical path configured to engage with the mobile member.

13. The writing instrument of claim 12, wherein the slider comprises a cam path follower configured to engage with the helical path and travel along the helical path when the rotating body is caused to rotate about the longitudinal axis with respect to the body.

14. The writing instrument of claim 13, wherein the cam path follower is arranged at an outer periphery of the slider.

15. The writing instrument of claim 1, wherein the writing tip is a porous tip.
